(19) United States
(12) Patent Application Publication
(10) Pub. No.: US 2012/0156440 A1
(43) Pub. Date: Jun. 21, 2012

(54) Translucent, Flame Resistant Composite Materials

(75) Inventors: Daniel W. Cushing, Covington, WA (US); Eugene A. Jackson, Deer Park, WA (US); Keith H. Novak, Tukwila, WA (US); David N. Dunn, Marysville, WA (US); Gregory R. Bell, Renton, WA (US)

(73) Assignee: THE BOEING COMPANY, Chicago, IL (US)

(21) Appl. No.: 13/048,704

(22) Filed: Mar. 15, 2011

Related U.S. Application Data
(63) Continuation-in-part of application No. 12/577,618, filed on Oct. 12, 2009, now Pat. No. 8,007,620.
Application No. 12/577,618 is a division of application No. 10/707,612, filed on Dec. 24, 2003, now abandoned.

(51) Int. Cl. B32B 3/00; B32B 7/02; B32B 5/26; D04H 13/00

(52) U.S. Cl. 428/195.1; 442/416; 428/212; 442/391

(57) ABSTRACT

A translucent composite material comprises a substrate and a plurality of glass fibers embedded within the substrate. The substrate may comprise a substantially continuous nonwoven, non-fabric, translucent thermoplastic polyphenylsulfone substrate. The plurality of glass fibers may substantially span across a length of the substrate and may have an orientation, a fiber thickness, and a fiber area density selected to provide the translucent composite material with a strength, a flame-resistance, and a light transmissivity.

### RELATED APPLICATION

This application is a Continuation-in-Part of U.S. patent application Ser. No. 12/577,618 filed Oct. 12, 2009, status pending, which, in turn, is a Divisional of U.S. patent application Ser. No. 10/707,612, filed Dec. 24, 2003, status abandoned.

### BACKGROUND INFORMATION

1. Field

The present invention generally relates to composite materials and more specifically to translucent, flame resistant composite materials that may be used in aircraft interiors and other aerospace applications.

2. Background

The interiors of commercial aircraft are typically formed with a large number of components in many shapes and forms that have both practical and aesthetic functions. It is also highly desirable that certain of these components be translucent, i.e. that these components allow light to pass through diffusely, for various purposes. Examples of translucent interior components may include but are not limited to partitions, windscreens, class dividers, privacy curtains, sidewalls, ceilings, doorway linings, lighting fixtures, backlit control panels, stow bin doors, tray tables, proximity lighting, and window bezels.

While translucency is desired, materials used in aircraft interior components must meet strict Federal Aviation Administration (FAA) requirements in terms of flame resistance properties (FAR 25.853 and Appendix F), including heat release, vertical burn, smoke emissions tests, and toxic fume emissions tests. For example, the standard test method for heat release is the Ohio State University heat release test as found in FAR 25.853-Part IV.

Prior art plastic materials used in commercial aircraft could not typically achieve the combination of a desired transmissivity of light while meeting FAA requirements in terms of flame resistance properties (FAR 25.853 and Appendix F), vertical burn, smoke emissions tests, and toxic fume emissions tests. As such, interior components have typically been made of non-translucent (opaque), or marginally translucent plastic materials that meet these FAA flame resistance requirements. A marginally translucent material requires a powerful light source to provide a useful amount of light transmission through the material.

It is highly desirable to form a material that can be post-processed to form substantially translucent interior components for use in commercial aircraft cabins that meets or exceeds FAA requirements as described above. It is also desirable that such a material be low cost in terms of manufacture and raw material costs. It is also highly desirable that such a material be low in weight and easily conformable to form a potentially limitless variety of shapes and configurations for these components.

### SUMMARY

The present invention discloses composite materials that meet or exceed the FAA requirements in terms of flame resistance properties (FAR 25.853 and Appendix F), including heat release, vertical burn, smoke emissions tests, and toxic fume emissions tests. The composite materials can be post-processed to form various translucent components that may be used throughout the interior of a cabin on an aircraft and that allow transmissivity of desirable amounts of light.

The composite material has long glass fibers encapsulated within a polyphenylsulfone (PPSU) substrate material. The long glass fibers are preferably configured within a loose weave or may alternatively be unidirectional in nature so long as the fibers meet the requirements for light transmission and flame resistance.

The composite material may be formed as a two-layer or three-layer system. In the two-layer system, the glass fibers are laminated to one side of the PPSU substrate. In a three-layer system, the glass fibers are sandwiched between and laminated to two layers of the PPSU substrate. The preferred manufacturing processes identified for forming two-layer or three-layer panels include a thermal pressing process and a continuous fiber impregnation process. The composite panels may be cut and thermoformed or bended to the shape of the final part.

In one advantageous embodiment, a translucent composite material comprises a substrate and a plurality of glass fibers embedded within the substrate. The substrate may comprise a substantially continuous nonwoven, non-fabric, translucent thermoplastic polyphenylsulfone substrate. The plurality of glass fibers may substantially span across a length of the substrate and may have an orientation, a fiber thickness, and a fiber area density selected to provide the translucent composite material with a strength, a flame-resistance, and a light transmissivity.

In another advantageous embodiment, a translucent composite material comprises a substrate and a plurality of glass fibers embedded within the substrate. The substrate may comprise a substantially continuous nonwoven, non-fabric, translucent thermoplastic polyphenylsulfone substrate. The plurality of glass fibers may substantially span across a length of the substrate, have a melting temperature above a melting temperature of the least one substrate, may be selected from a group consisting of a plurality of long s-type glass fibers and a plurality of long e-type glass fibers, and may have an orientation, a fiber thickness, and a fiber area density selected to provide the translucent composite material with a strength, a flame-resistance, and a light transmissivity, the translucent composite material may have an average allowable heat release not exceeding a 65/65 standard and may be configured to be post processed to form a translucent flame-resistant component.

In yet another advantageous embodiment, a three layer translucent composite material may comprise a first layer comprising a substantially continuous nonwoven, non-fabric, translucent thermoplastic polyphenylsulfone substrate; a second layer comprising a substantially continuous nonwoven, non-fabric, translucent thermoplastic polyphenylsulfone substrate; and a third layer comprising a plurality of woven long glass fibers laminated between the first layer and the second layer. The plurality of woven long glass fibers may substantially span across a length of the first layer and the second layer. The plurality of woven long glass fibers may have a melting temperature above a melting temperature of both of the substantially continuous nonwoven, non-fabric, translucent thermoplastic polyphenylsulfone substrates. The plurality of woven long glass fibers may be selected from a group consisting of a plurality of long s-type glass fibers and a plurality of long e-type glass fibers. The plurality of woven long glass fibers may have an area density having a value equal to or less than about four ounces per square yard and may be selected to provide the translucent composite material with a strength, a flame-resistance, and a light transmissivity. The translucent composite material may have an average allowable heat release not exceeding a 65/65 standard and may be configured to be post processed to form a translucent flame-resistant component.

Advantages of the present invention will become apparent upon considering the following detailed description and appended claims, and upon reference to the accompanying drawings.

The features, functions, and advantages can be achieved independently in various embodiments of the present disclosure or may be combined in yet other embodiments in which further details can be seen with reference to the following description and drawings.

### BRIEF DESCRIPTION OF THE DRAWINGS

FIGS. 1-14 illustrate various perspective views of a cabin region of a commercial aircraft having translucent, flame resistant components formed according to advantageous embodiments;

FIG. 15 is a side view of a two-layer composite material having weaved fibrous material used to form translucent, flame resistant components such as the components illustrated in FIGS. 1-14 according to an advantageous embodiment;

FIG. 16 a side view of a three-layer composite material used to form translucent, flame resistant components such as the components illustrated in FIGS. 1-14 according to an advantageous embodiment;

FIG. 17 is a side view a two-layer composite material having unidirectional fibers used to form translucent, flame resistant components such as the components illustrated in FIGS. 1-14 according to an advantageous embodiment;

FIG. 18 is a table that illustrates exemplary composite panel configurations according to an advantageous embodiment; and

FIG. 19 is a table that illustrates test results according to an advantageous embodiment.

### DETAILED DESCRIPTION

The following disclosure describes the formation of composite materials that are ideally suited for use as translucent components for various devices contained within cabin areas of commercial aircraft due to their light transmissivity properties and flame resistance. As one of ordinary skill recognizes, however, the composite materials may be used in other applications not directly related to commercial aircraft. For example, the composite materials could find usage in other aerospace applications or even in non-aerospace applications such as automotive applications.

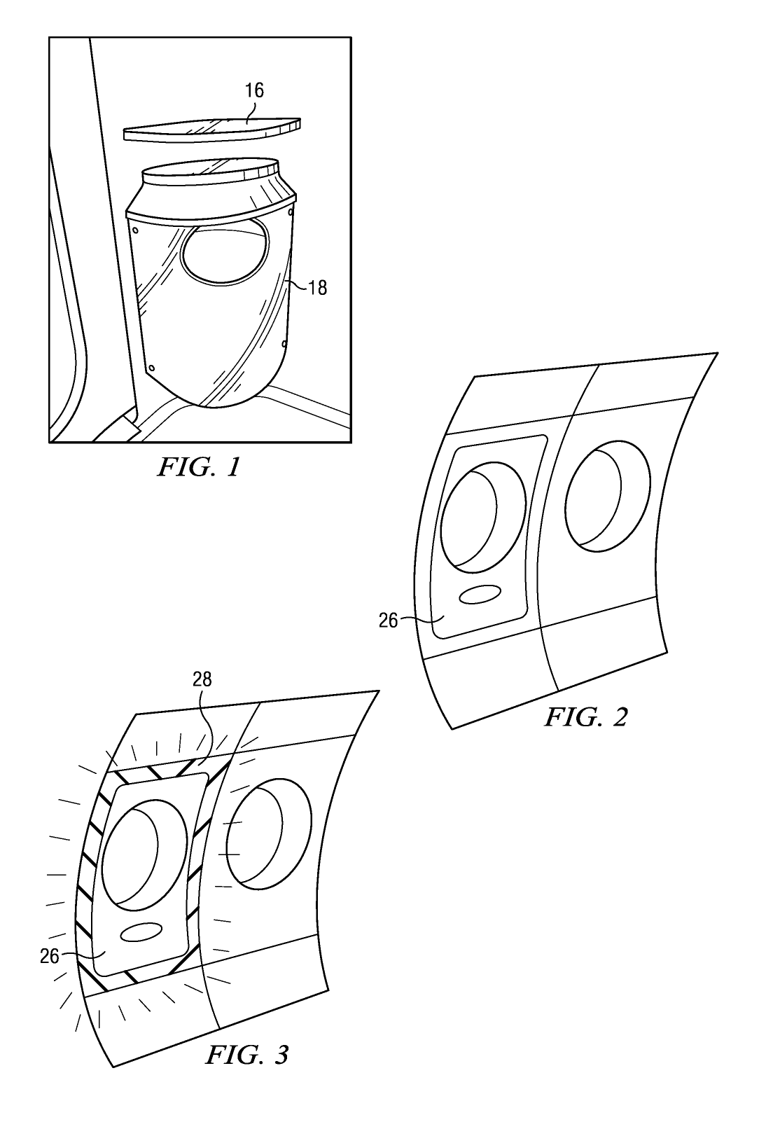

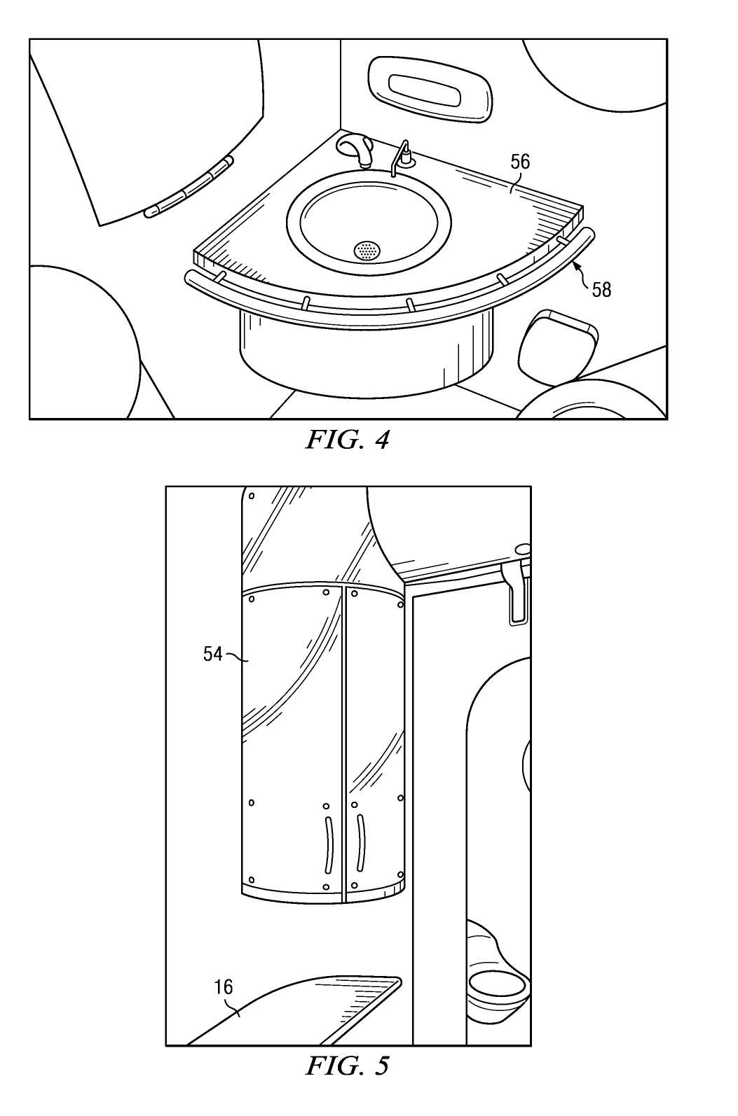

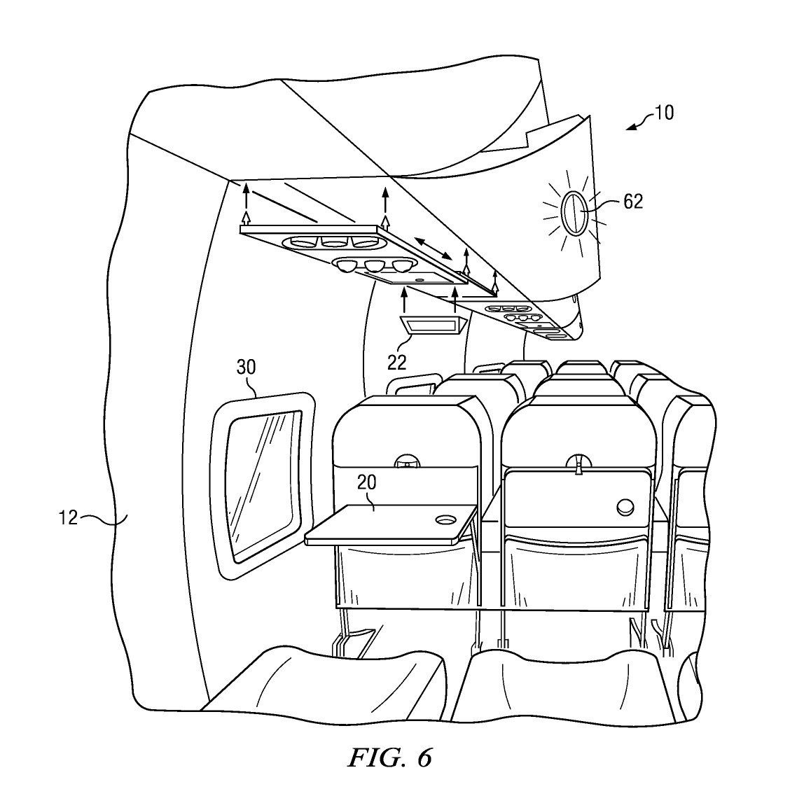

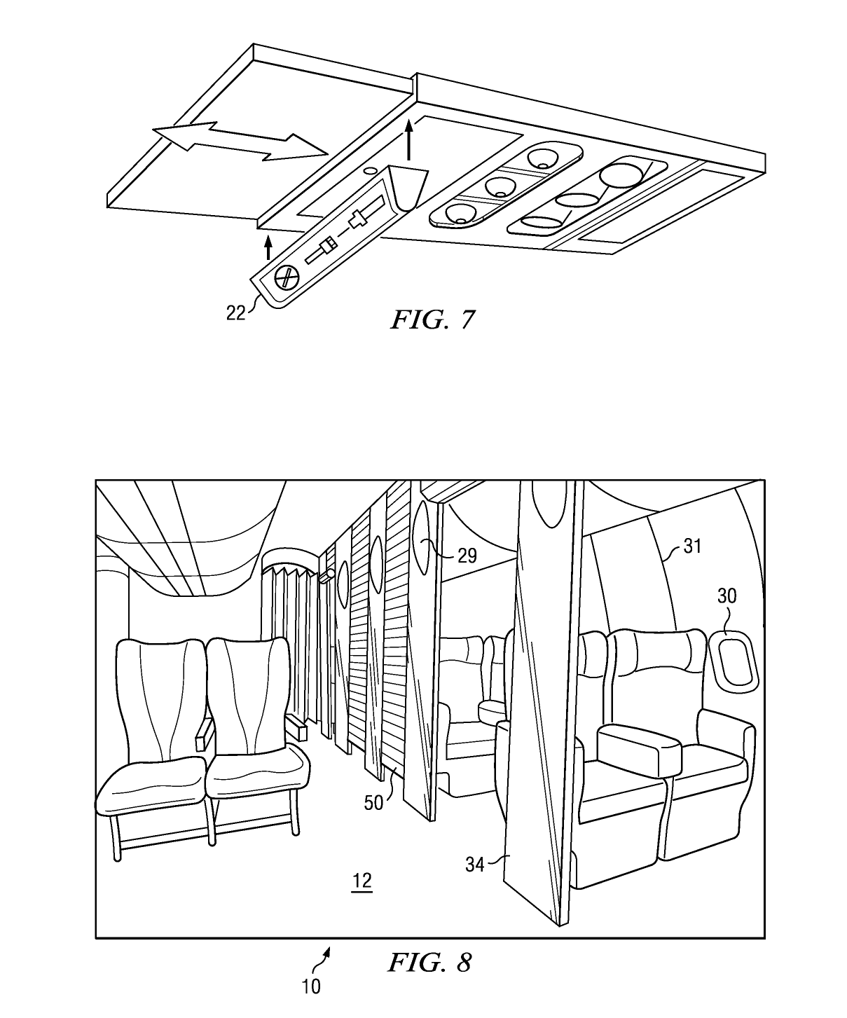

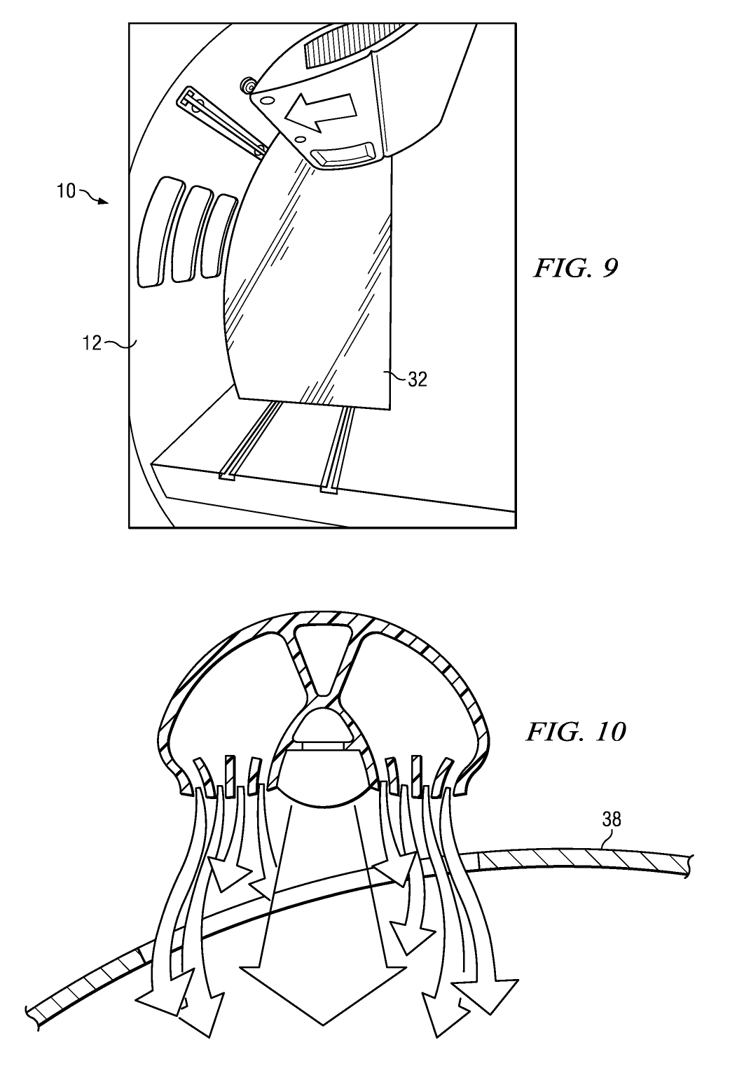

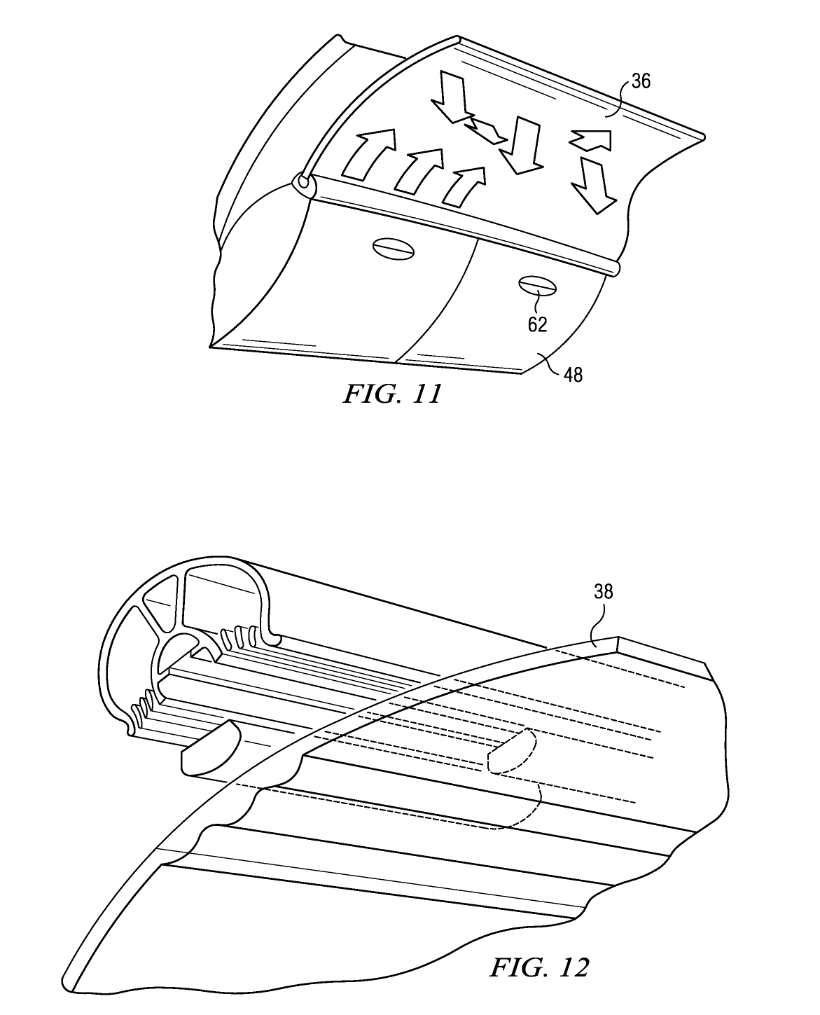

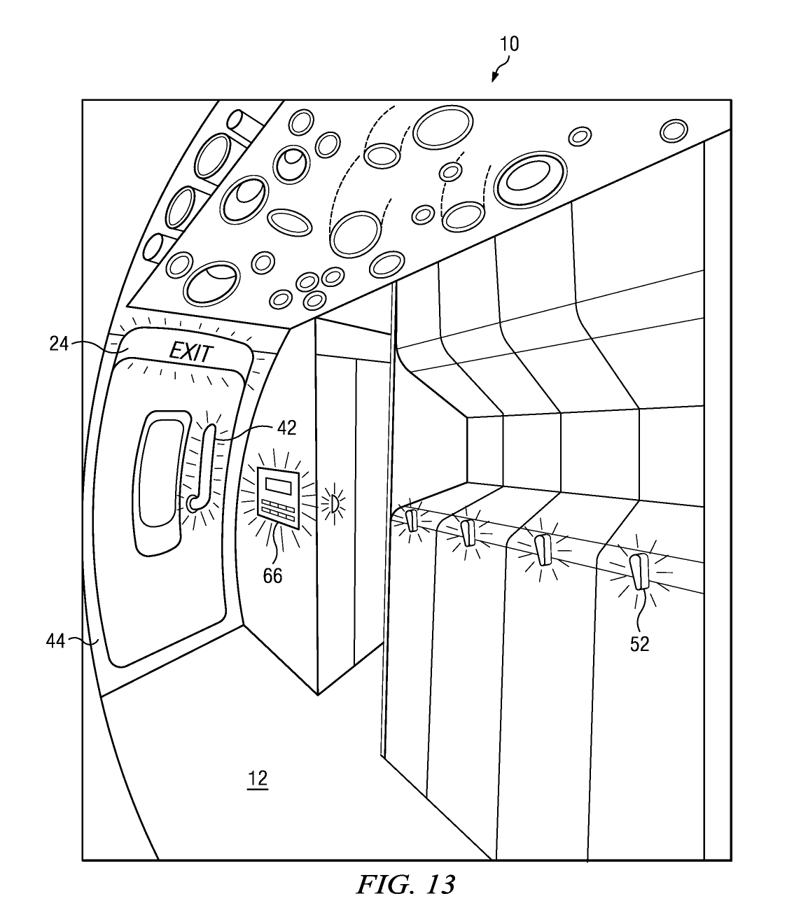

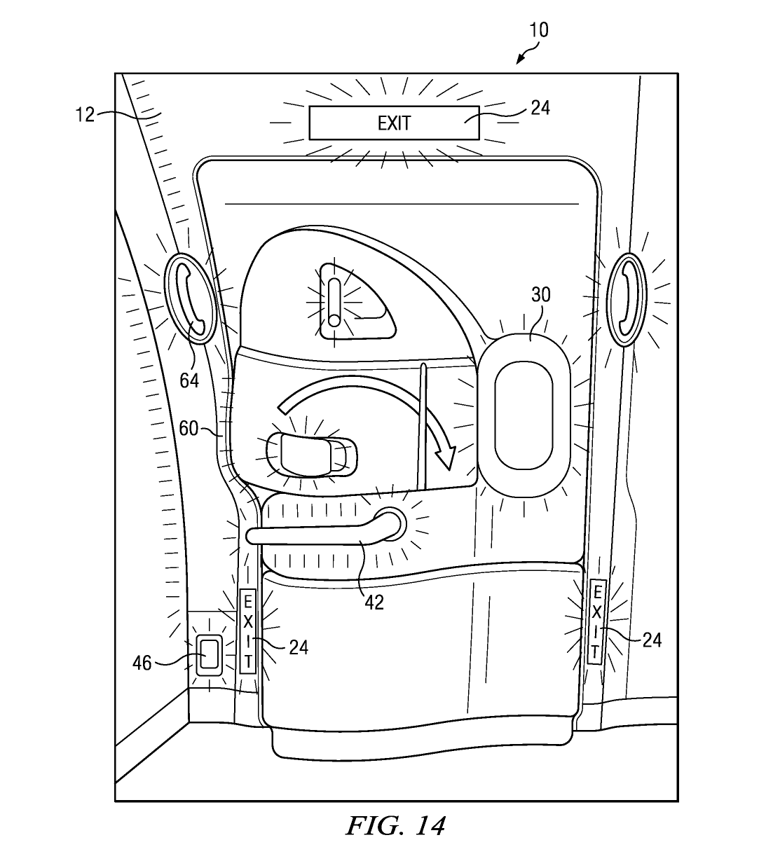

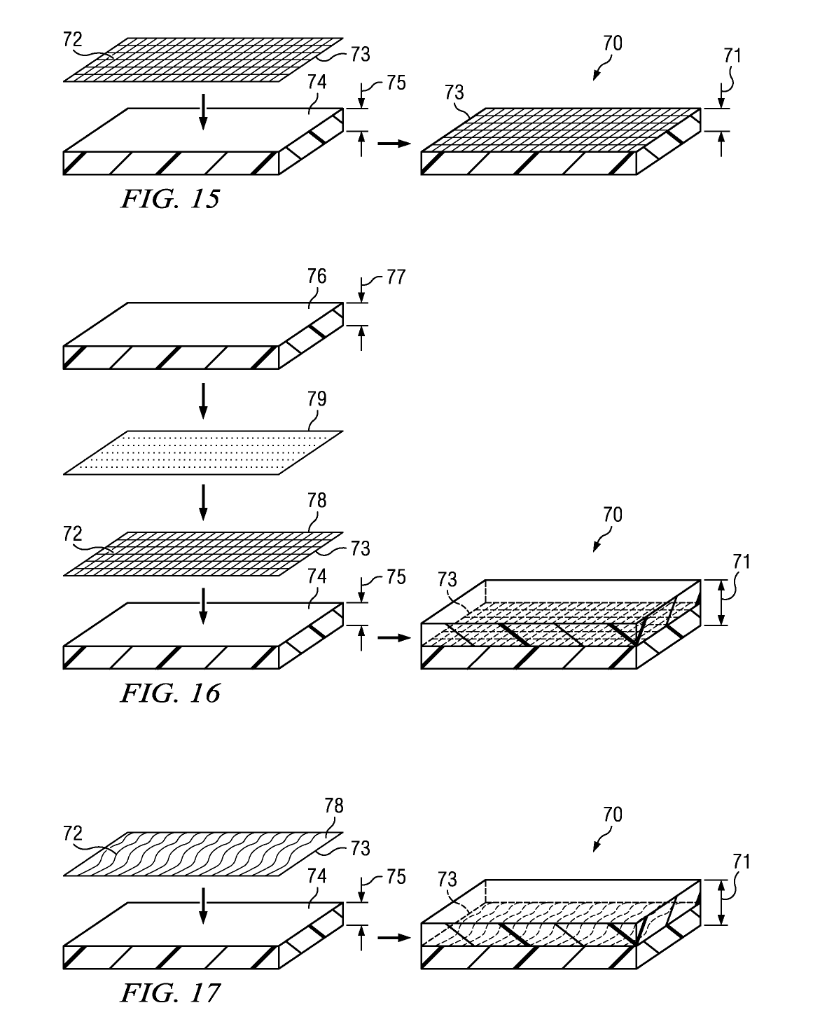

FIGS. 1-14 illustrate various perspective views of a cabin region of a commercial aircraft having translucent, flame resistant components formed according to illustrative embodiments. In particular, FIGS. 1-14 illustrate various views of an interior, or cabin region 12, of a commercial aircraft 10. The aircraft 10 has a wide variety of translucent, flame resistant components that are traditionally found within the cabin region 12 that are formed from a novel composite material 70 illustrated in FIGS. 15 to 17.

The components formed are light transmissive to allow for a pleasing glow or to allow for use as primary lighting within the cabin region 12. The components formed may be a substantially translucent material. A substantially translucent material, as used herein is a material that allows sufficient light transmission such that a relatively small light source can allow the material to achieve a number of useful lighting functions. For example, without limitation, these lighting functions may include: a) a diffuse lighting source for general illumination, b) backlighting signs, c) identification of user interfaces such as door handles or control buttons, and d) general décor such as surfaces that have a pleasing glow but do not provide a primary source of light.

The composite materials also meet flammability standards. For example, the standard test method for heat release is the Ohio State University heat release test as found in FAR 25.853, Part IV, in which the maximum allowable average heat release for interior panels contained with the cabin area of commercial airlines does not exceed 65 kw/m² as measure at a two minute interval and for a peak rate at five minutes. This is also known in the industry as the 65/65 standard (peak heat release/total heat release).

The translucent components also meet Federal Aviation Association (FAA) certification requirements for materials used overhead in the passenger cabin area 12. These certification requirements state that the composite material 70 must not drip or dislodge from their designated flight configuration such that they inhibit egress when exposed to a temperature of 500 degrees Fahrenheit (260 degrees Celsius) for five minutes.

Non-limiting examples of translucent, flame resistant components that are formed from the composite material 70, and that are illustrated in FIGS. 1-14, include countertops 16, cabinet enclosures 18 such as wastebaskets, tray tables 20, backlit lighted signs 22 such as emergency exit signs 24, illuminating window panels 26 having light emitting diode displays 28, window bezels 30, cabin panel 31, class dividers 32, privacy partitions 34, backlit ceiling panels 36, direct lighting ceiling panels 38, lighted doors 40, lighted door latches 42, doorway linings 44, proximity lights 46, stow bin doors 48, privacy curtains 50, translucent door handles 52 (capable of changing from red to green, for example), translucent amenities cabinets 54, translucent sink decks 56 for lavatories and kitchens (with or without an appropriate undersink enclosure 58), doorway liners 60, stow bin latch handles 62, lighted phones 64, and backlit control panels 66. While these components are illustrated in one preferred arrangement, it is understood that the number, type, and location of these translucent, flame resistant components may vary greatly among various types of commercial aircraft 10 are not meant to be limited to the illustrated arrangement.

FIGS. 15-17 illustrate three preferred composite materials 70 that can subsequently be post-processed to form translucent, flame resistant components such as illustrated in FIGS. 1-14. In particular, FIG. 15 illustrates a side view of a two-layer composite material having weaved fibrous material used to form translucent, flame resistant components according to an illustrative embodiment; FIG. 16 illustrates a side view of a three-layer composite material used to form translucent, flame resistant components such as the components illustrated in FIGS. 1-14 according to an illustrative embodiment; and FIG. 17 illustrates a side view a two-layer composite material having unidirectional fibers used to form translucent, flame resistant components such as the components illustrated in FIGS. 1-14 according to an illustrative embodiment. Each is described below.

Referring now to FIG. 15, the two-layer composite material 70 is formed by laminating a layer of weaved fibrous material 72 to a substrate material 74. In FIG. 16, a three-layer composite material 70 is formed by introducing a second layer of substrate material 76 having the same composition as first layer 74 such that the fibrous material 72 is sandwiched and laminated between first and second layer 74, 76. In an alternative preferred embodiment, as shown in FIG. 17, a unidirectional, non-weaved fibrous material 72 is laminated to the substrate material 74 to form another two-layer translucent, flame resistant composite material 70. In FIGS. 15-17, the composite material 70 comprises composite panels, however, it should be recognized that the composite material may be formed in other shapes, as well.

Of course, while three preferred embodiments are illustrated in FIGS. 15-17, other preferred embodiments are specifically contemplated. For instance, one three-layer composite material 70 consists of a weaved fibrous material 72 sandwiched between and laminated to the first layer 74 and second layer 76 as in FIG. 16. Also, two layers of fibrous material 72 (weaved or unidirectional) could be introduced to a top and bottom surface of the substrate material 74 to form another composite material 70.

The substrate material 74 is chosen based on the particular application for which it is utilized. In the case of airplane interior components, the substrate material 74 is chosen to allow adequate light transmissivity for the desired component. In particular, to be adequate, transmissivity may need to be sufficient to perform specific function. However, the amount of transmissivity required may depend on the specific function. For example, for general illumination of the cabin area, significantly more transmission may be required than for functions such as backlight signs or glowing door handles. In some examples, the requirement may be subjective such as when the translucent material is performing a décor function. In other examples, such as general lighting, a percentage of visible light transmission may be required or a specified number of foot candles at a prescribed area may be required.

The substrate material 74 has the ability to soften to permit lamination of the fibrous material 72 as well as being able to be post processed to form a translucent component having a desired shape and thickness. It is also desirable that the substrate material 74 is low cost, durable, and is available in varying thickness to provide design flexibility. Additionally, the substrate material 74 should be compatible with the fibrous material 72 and resist degradation due to light, heat, and stress.

One thermoplastic resin that meets these requirements is polyphenylsulfone, otherwise known as PPSU. PPSU is a substantially continuous, non-woven, non-fabric thermoplastic material that is relatively light transmissive and typically has a light brown tint. As one of ordinary skill appreciates, many grades of PPSU are commercially available, each having slightly varying transmissivity and flame resistant properties. One preferred PPSU material is Radel PPSU, available from Solvay Advanced Polymers, LLC.

In accordance with advantageous embodiments, and as will be explained more fully hereinafter, the transmissivity and flame resistance properties of PPSU is specifically tailored through selecting the appropriate thickness and grade of the polyphenylsulfone and/or by appropriate fiber and weave selection. Advantageous embodiments provide specific combinations that enable both functions to be achieved simultaneously.

The fibrous material 72 is added to the PPSU substrate material 74, 76 to provide retention of the composite panel 70 in the event of fire. In particular, the fibrous material 72 laminated within the substrate 74 or between substrates 74, 76 allows compliance with the FAA certification requirement for flame resistance properties, including heat release, vertical burn, smoke emissions tests, and toxic fume emissions tests. Long glass fibers 78 are preferred for use as the fibrous material 72 due to their ability to act as thermal insulators, their ability to allow the composite panel 70 to pass flammability tests, their ability to not overly decrease light transmissivity, and their overall appearance within the PPSU substrate 74, 76.

The long glass fibers 78 utilized should have a thread count that is coarse enough to allow sufficient light transmission between the fibers 78 and through the substrate 74, 76. Also, there should be sufficient volume of fibers 78 in the fibrous material 72 to produce a thermal insulation capacity necessary to achieve at least the minimum flammability properties. Further, visible fibers 78 in the composite material 70 should have a consistent appearance. Additionally, a sufficient area density of fibers 78 should be present to ensure adequate article retention. “Adequate article retention” is the ability to retain the entire article including the substrate when placed in a 500 degree Fahrenheit environment for five minutes. The article must remain in the article's attachment fixture and no material may dislodge or drip from the article. Due to testing limitations, the test oven must be at a minimum of 425 degrees Fahrenheit when the test article is placed inside the oven, and the oven must have reached 500 degrees Fahrenheit by five minutes.

Preferably, the long glass fibers 78 have melting temperatures substantially above the melting temperature of the PPSU substrate 74. Preferably, the glass fibers are able to support the PPSU substrate 74 once the PPSU substrate 74, 76 is softened at about 500 degrees Fahrenheit. Two types of glass fibers 78 that have thermal properties that meet these criteria are e-glass and s-glass fibers. In addition, an added benefit of using long glass fibers is that because they span the entire composite material, the fibers allow improved article retention of the composite material at elevated temperature. Fibers which do not span from one retention point to another leave loose ends within the substrate that may separate from one another within the substrate.

The fiber area density, and the thickness, and orientation of the fibers are all properties that may be optimized for a particular application. A higher area density of fibers 78 or thicker fibers 78, within the PPSU substrate 74 will provide additional strength and will act as a heat sink when the composite panel 70 is exposed to fire, however, it may adversely affect the light transmissivity and the overall weight of the composite panel. The particular fiber orientation utilized, or fiber weave, may also affect the weight, flammability, overall fire retention, material strength, and light transmission of the composite panel. Thus, if more light transmission is desired, such as in a backlit light sign 22 or an emergency exit sign, the fiber area density, thickness, and the orientation may be set to allow maximum transmissivity while maintaining the 65/65 standard. With components such as tray tables 20, the area density of glass fiber, for example, may be increased compared to backlit light signs 22, as a maximum transmissivity of light is not necessary and a lesser light transmissivity may be satisfactory.

In these advantageous embodiments, fibrous material 72 may provide greater flame resistance than substrate material 74 or substrate material 76. For composite material 70 made of two layers, as illustrated in FIG. 15, advantageous embodiments may place fibrous material 72 along a surface that is more likely to encounter heat. For example, if composite material 70 is used in cabin panel 31, portion of composite material 70 may be formed such that fibrous material 72 is facing outside of cabin 12.

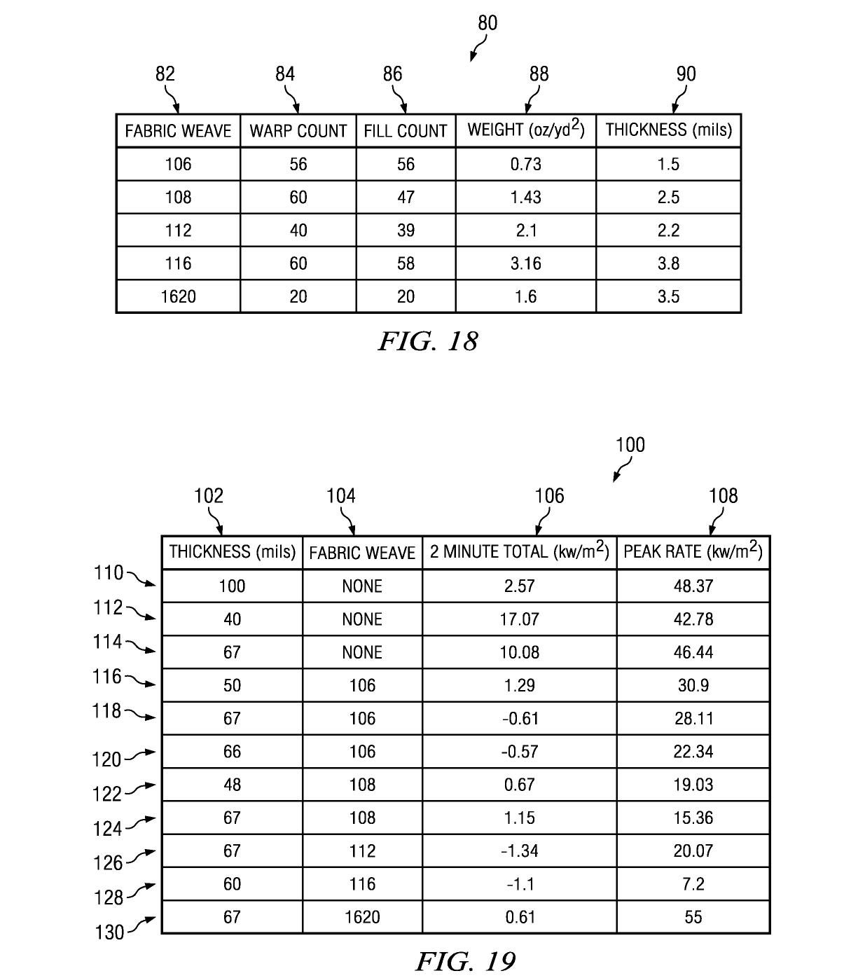

With reference now to FIG. 18, a table that illustrates exemplary composite panel configurations is depicted in accordance with an advantageous embodiment. The table is generally designated by reference number 80, and illustrates various PPSU components that are both translucent and flame resistant and that are suitable for use in forming interior components for use in commercial aircraft cabins. FIG. 18 illustrates, for each configuration, the fabric weave 82, the warp count 84, the fill count 86, the weight 88 and component thickness 90.

In FIG. 18, warp count 84 refers to the fibers in the direction of the fabric roll. The fibers are continuous along the length of the roll. Fill count 86 refers to fibers parallel to the direction of the roll. Warp count 84 and fill count 86 are the number of warp and fill fibers, respectively, per inch. Weight 88 refers to the weight of the woven fiber material in ounces per square yard. Weight 88 is also the area density of the woven fiber material. As used herein, area density is the mass or weight of a material per unit of area. Thickness 90 is the nominal thickness of the woven material.

In general, translucency may decrease with an increase in the thickness of the substrate and the area density of the woven fiber material. However, the area density of the woven fiber material may have a greater impact on the translucency of the composite material than the thickness of the substrate.

For example, fibers may be translucent. Fibers may be round or may be flat in shape. The shape of the fibers may cause light passing through the fibers to refract. Additionally, the fibers may be partially opaque and reflect or block light from passing through. In a composite material including fibers, the area density of fibers may have a direct impact on the amount of light that can pass through the composite material. The greater area density of the fibers the greater the amount of light that is refracted inside the composite material and may not pass through the composite material. The amount of light that does not pass through the material decreases the translucency of the composite material. Accordingly, advantageous embodiments match desired values of translucency for the composite material with selections of area density of the fibers.

Additionally, the strength of the composite material may increase with an increase in the thickness of the substrate and the density of the woven fiber material. However, the area density of the woven fiber material may have a greater impact on the strength of the composite material than the thickness of the substrate.

The strength of the composite material may be determined by adding the elastic modulus of the substrate multiplied by the percentage of substrate in the composite material by weight with the elastic modulus of the fibers multiplied by the percentage by weight of fibers in the test direction. Selection of the area density of fibers, the specific fibers used, the orientation of the fibers and the thickness of the substrate allows tailoring of the strength of the composite material in specific directions.

Article retention and the strength of the composite material may be increased in directions that are parallel with the fibers. Thus, woven fabrics may improve these characteristics more uniformly throughout the composite material than unidirectional fabrics. However, unidirectional fabrics may be easier to mold into complex contours than are woven fabrics.

The composite material 70 may be formed by many different and unique methods. Two preferred methods for forming the composite material 70 are the thermal pressing process and the continuous fiber impregnation process. Each is described below with respect to the two-layer composite material 70 of FIG. 15. However, as one of ordinary skill recognizes, the same preferred processes may be manipulated slightly to form the three-layer composite material 70 of FIG. 16 or the two-layer composite material 70 having unidirectional fibers 78 as in FIG. 17.

In the thermal pressing process, the substrate material 74 and fibrous material 72 are first introduced within a mold. The mold is first heated under controlled pressure to soften the substrate material 74. This is known as the preheating stage. Next, in the impregnation stage, higher heat and pressure are introduced to laminate the fibrous material 72 to the substrate material 74. The higher heat and pressure allows the impregnation of the embedded glass fibers 78 of the fibrous material 72 and substantially encapsulates the fibers 78 with the PPSU substrate material 74, therein forming the composite material 70. Finally, in the cooling stage, the composite material is cooled under controlled heat and pressure conditions to control internal stresses and warpage.

In one preferred example of this process, a composite sheet 70 of about 0.1 inches in thickness is formed by first introducing the PPSU substrate material 74 and fibrous material 72 to a mold. Next, in the preheating stage, the mold is heated to about 535 degrees Fahrenheit over about 15 minutes.

The mold is then held at 535 degrees for about 55 minutes during the impregnation stage. During this time, the pressure is ratcheted upward slowly to prevent outgassing of the PPSU substrate material, therein preventing bubbles from being formed within the composite sheet 70. Thus, between 0 and 5 minutes, the pressure is maintained at about 15 pounds per square inch part pressure. Between 5 and 27 minutes, the pressure is maintained at about 50 pounds per square inch part pressure. Between 27 and 47 minutes, the pressure is maintained at about 100 pounds per square inch part pressure. Finally, between 47 and 55 minutes, the pressure is maintained at about 200 pounds per square inch part pressure.

Next, in the cooling stage, the composite part is allowed to slowly cool down to 235 degrees Fahrenheit under constant pressure of about 200 pounds per square inch part pressure. The cooling rate is maintained at about 5 degrees Fahrenheit per minute, thus this portion of the cooling stage lasts approximately one hour to control internal stresses and warpage of the forming composite part.

Next, to further cool the composite part, the temperature within the mold is slowly decreased to about 150 degrees Fahrenheit and 100 pounds per square inch part pressure to further control internal stresses and warpage. Finally, the mold is opened and the composite sheet 70 is allowed to cool to room temperature.

The thermal pressing technique has many benefits over other techniques used for forming composite materials. First, the fibers 78 are substantially encapsulated with the PPSU substrate material. Also, thermal pressing at a temperature below the melting point of the PPSU substrate allows sufficient flex without yield. Finally, the thermal pressing technique also allows the incorporation of decorative features into the composite material. For example, screen print 79 may be added to the fibers 78 prior to adding the fibers 78 to the PPSU substrate material 74.

By adding screen print 79 to fibers 78, the screen print 79 will be visible through the substrate in the finished product. As a result, light passing through the finished product may provide a visually appealing glow.

In the continuous impregnation technique, molten PPSU resin making up the substrate material 74 is introduced from an extruder having a die set between a pair of rollers contained within a calendar roll stack. At the same time, a sheet layer of fibrous material 72 is unrolled from a roller onto the molten layer between the first set of rollers. The calendar roll stack, preferably containing three or more stainless steel calendar rolls stacked vertically, presses the fibrous material sheet layer and molten layer to a desired thickness, therein impregnating the PPSU resin within the fibrous material 72. The composite material 70 formed then is removed from the calendar rolls stack on a conveyor belt line and allowed to cool, therein forming a cooled, hardened composite sheet 70.

The continuous impregnation technique offers slightly different benefits to the thermal pressing technique. For example, because the process is continuous, the composite sheet material 70 may be formed at a quicker rate than with the thermal pressing technique. This may also be cost effective. Also, the thickness of the material formed may be easily modified by adjusting the clearance gap between the respective rollers of the calendar stack. Additionally, the process also automates impregnation techniques that would otherwise have to be accomplished manually.

In these advantageous embodiments, thickness 75 of substrate material 74 and thickness 77 of substrate material 76 may vary. For example, in some advantageous embodiments thickness 75 and thickness 77 may vary from about 40 mils to 150 mils. As discussed above, composite material 70 may be compressed when formed by laminating fibrous material 72 into substrate material 74 or between substrate materials 74, 76. As a result, thickness 71 of composite material 70 may vary from about 40 mils to 200 mils.

As illustrated in FIGS. 15-17, thickness 75 of substrate material 74 and thickness 77 of substrate material 76 are greater than fiber thickness 73 of fibrous material 72. As a result, thickness 71 of composite material 70 is also greater than fiber thickness 73 of fibrous material 72. As illustrated in FIG. 18, advantageous embodiments include woven fiber materials having thickness 90 from about 1.5 mils to 3.8 mils. The woven fiber materials remain substantially unchanged during the forming process when embedded into the substrate material 74 or laminated between substrate material 74 and substrate material 76.

While thickness 71 of composite material 70 may vary, fiber thickness 73 in composite material may be less than 10% of thickness 71. For example, composite material 70 may have thickness 71 of about 40 mils while fiber thickness 73 is about 3.8 mils. Thus, fiber thickness 73 may be about 9.5% of thickness 71 of composite material 70. In another example, thickness 71 may be about 100 mils while fiber thickness 73 is about 1.5 mils. Thus, fiber thickness 73 may be about 1.5% of thickness 71 of composite material 70.

After the composite material 70 is formed by either of the preferred techniques described above or by any other techniques known to those of skill in the art, the composite material 70 is then available to be post-processed for the desired application. The type of post processing depends upon the component to be manufactured, and typically involves cutting, bending or thermoforming the part to a desired shape and size.

For example, a privacy curtain 50 must remain flexible, and is thus formed as a very thin composite material. Conversely, a countertop 16 must be able to support items placed upon it, and thus is formed with a thickness much greater than the privacy curtain 50.

Also, for example, the amount of light transmissivity may vary based upon the ultimate use of the component. Thus, an emergency exit sign 24 may be formed of a thin composite material 70 and with a lower fiber thread per unit area, therein allowing maximum light transmissivity. Conversely, a ceiling may be formed with minimal light transmissivity having higher fiber thread count per unit area, therein providing maximum flame resistance.

The composite component is then available for use within the cabin area 12. To form the component, the composite material 70 having the desired light transmissivity and flame resistant characteristics as described above is bent, cut thermoformed or otherwise post-processed in methods well known in the art to shape and size the part to the desired configuration.

With reference now to FIG. 19, a table illustrating test results is depicted in accordance with an illustrative embodiment. Table 100 includes results of testing materials 110-130 using the Ohio State University heat release test mentioned previously. Materials 110-130 were exposed to a heat source having a heat flux of about 3.5 watts per square centimeter for a period of at least five minutes.

Two minute total 106 is a total of an amount of heat release over the first two minutes of testing. The amount of heat release is measured in kilowatts per square meter. A negative value for two minute total 106 indicates that the material absorbed more heat than the material released. Peak rate 108 is an amount of heat release at point during the first five minutes of the test when the material is burning most intensely. In table 100, a sample for each of materials 110-130 was tested three times. The values for two minute total 106 and peak rate 108 are an average of the three tests.

Thickness is the thickness of materials 110-130 that were tested in mils. Fabric weave 104 is an identifier of a type of fabric material. Fabric weave 104 corresponds with fabric weave 82 in FIG. 18. As illustrated, materials 110-114 did not include any fabric material.

As illustrated in table 100, materials 116-130 containing fabric material generally have lower values for two minute total 106 and peak rate 108 than materials 110-114 that do not include any fabric material. For example in every instance two minute total 106 was lower for materials 116-130 containing fabric material. Also in every instance, materials 116-130 had values for two minute total 106 and peak rate 108 that are lower than 65 kilowatts per square meter.

While the invention has been described in terms of preferred embodiments, it will be understood, of course, that the invention is not limited thereto since modifications may be made by those skilled in the art, particularly in light of the foregoing teachings.

The description of the different advantageous embodiments has been presented for purposes of illustration and description, and is not intended to be exhaustive or limited to the embodiments in the form disclosed. Many modifications and variations will be apparent to those of ordinary skill in the art. Further, different advantageous embodiments may provide different advantages as compared to other advantageous embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A translucent composite material comprising:
a substrate comprising a substantially continuous nonwoven, non-fabric, translucent thermoplastic polyphenylsulfone substrate; and
a plurality of glass fibers embedded within the substrate, the plurality of glass fibers substantially spanning across a length of the substrate and having an orientation, a fiber thickness, and a fiber area density selected to provide the translucent composite material with a strength, a flame resistance, and a light transmissivity.

2. The translucent composite material of claim 1, wherein the plurality of glass fibers has an area density having a value equal to or less than about four ounces per square yard.

3. The translucent composite material of claim 1, wherein a value for the fiber thickness of the plurality of glass fibers is equal to or less than about ten percent of a value of a thickness of the translucent composite material.

4. The translucent composite material of claim 1 further comprising:
a translucent flame-resistant component formed from the translucent composite material, the translucent composite material having an average allowable heat release not exceeding a 65/65 standard, wherein the plurality of glass fibers have a melting temperature above a melting temperature of the substrate, and wherein the plurality of glass fibers are selected from a group consisting of a plurality of long s-type glass fibers and a plurality of long e-type glass fibers.

5. The translucent composite material of claim 4, wherein the translucent composite material is configured to be post processed to form the translucent flame-resistant component by at least one of bending, cutting, or thermoforming.

6. The translucent composite material of claim 4, wherein the plurality of glass fibers comprise a plurality of unidirectional long glass fibers.

7. The translucent composite material of claim 4, wherein the plurality long glass fibers comprise a plurality of woven glass fibers.

8. The translucent composite material of claim 1, wherein the plurality of glass fibers comprises a layer of long glass fibers laminated to a surface of the substrate.

9. The translucent composite material of claim 1, wherein the substrate is a first substrate and further comprising:
a second substrate comprising a substantially continuous nonwoven, non-fabric, translucent thermoplastic polyphenylsulfone substrate wherein the plurality of glass fibers comprises a layer of long glass fibers laminated between the first substrate and the second substrate.

10. The translucent composite material of claim 1, wherein the translucent composite material comprises an interior component within a commercial aircraft and wherein the interior component is selected from a group consisting of a countertop, a cabinet enclosure, a tray table, a backlit lighted sign, an illuminating window panel, a window bezel, a class divider, a privacy partition, a backlit ceiling panel, a direct lighting ceiling panel, a backlit control panel, a lighted door, a lighted door latch, a doorway lining, a proximity light, a stow bin door, a privacy curtain, a door handle, an amenities cabinet, a sink deck, a doorway liner, a stow bin latch handle, and a lighted phone.

11. The translucent composite material of claim 1 further comprising:
a screen print configured to filter light in a pattern, the screen print positioned on the plurality of glass fibers before the plurality of glass fibers are embedded within the substrate.

12. A translucent composite material comprising:
a substrate comprising a substantially continuous nonwoven, non-fabric, translucent thermoplastic polyphenylsulfone substrate; and
a plurality of glass fibers embedded within the substrate, the plurality of glass fibers substantially spanning across a length of the substrate, having a melting temperature above a melting temperature of the substrate, being selected from a group consisting of a plurality of long s-type glass fibers and a plurality of long e-type glass fibers, and having an orientation, a fiber thickness, and a fiber area density selected to provide the translucent composite material with a strength, a flame-resistance, and a light transmissivity, the translucent composite material having an average allowable heat release not exceeding a 65/65 standard, the translucent composite material forming a translucent flame-resistant component.

13. The translucent composite material of claim 12, wherein the substrate comprises one substrate, and wherein the plurality of glass fibers comprises a layer of long glass fibers laminated to a surface of the substrate.

14. The translucent composite material of claim 13, wherein the plurality long glass fibers comprise a plurality of woven glass fibers.

15. The translucent composite material of claim 13, wherein the plurality of glass fibers comprise a plurality of unidirectional long glass fibers.

16. The translucent composite material of claim 15, wherein the plurality of glass fibers have an area density having a value equal to or less than about four ounces per square yard and wherein the plurality of glass fibers have a fiber thickness having a value equal to or less than ten percent of a value of a thickness of the translucent composite material.

17. The translucent composite material of claim 16, wherein the substrate comprises two substrates, and wherein the plurality of glass fibers comprises a layer of long glass fibers laminated between the two substrates.

18. The translucent composite material of claim 17 further comprising:
a screen print configured to filter light in a pattern, the screen print positioned on the plurality of glass fibers before the plurality of glass fibers are embedded within the substrate.

19. The translucent composite material of claim 18, wherein the translucent flame-resistant component comprises an interior component within a commercial aircraft.

20. A three layer translucent composite material comprising:
a first layer comprising a substantially continuous nonwoven, non-fabric, translucent thermoplastic polyphenylsulfone substrate;
a second layer comprising a substantially continuous nonwoven, non-fabric, translucent thermoplastic polyphenylsulfone substrate; and
a third layer comprising a plurality of woven long glass fibers laminated between the first layer and the second layer, the plurality of woven long glass fibers substantially spanning across a length of the first layer and the second layer, having a melting temperature above a melting temperature of both of the substantially continuous nonwoven, non-fabric, translucent thermoplastic polyphenylsulfone substrates, being selected from a group consisting of a plurality of long s-type glass fibers and a plurality of long e-type glass fibers, and having an area density having a value equal to or less than about four ounces per square yard and selected to provide the translucent composite material with a strength, a flame-resistance, and a light transmissivity, the translucent composite material having an average allowable heat release not exceeding a 65/65 standard, the translucent composite material forming to a translucent flame-resistant component.
